(19) United States
(12) Patent Application Publication
(10) Pub. No.: US 2025/0071846 A1
(43) Pub. Date: Feb. 27, 2025

(54) METHOD PERFORMED BY USER EQUIPMENT, AND USER EQUIPMENT

(71) Applicant: SHARP KABUSHIKI KAISHA, Sakai City, Osaka (JP)

(72) Inventors: LEI LIU, Shanghai (CN); RENMAO LIU, Shanghai (CN)

(21) Appl. No.: 18/726,146

(22) PCT Filed: Jan. 5, 2023
(86) PCT No.: PCT/CN2023/070670

§ 371 Date: Jul. 2, 2024

(30) Foreign Application Priority Data
Jan. 6, 2022 (CN) 202210019042.4

(51) Int. Cl. H04W 76/20; H04W 8/22; H04W 92/18

(52) U.S. Cl. CPC H04W 76/20; H04W 8/22; H04W 92/18

(57) ABSTRACT

Provided in the present invention are a method performed by user equipment, and user equipment. The method includes: in the case that UE having a layer-2 U2N remote UE capability satisfies at least one of the following conditions, transmitting, by the UE, an RRC message to indicate an L2-ID to a network, wherein the conditions include: a UE capability enquiry message transmitted by the network is received; an RRC reconfiguration message transmitted by the network is received, and the message includes a measurement configuration of relay UE; the UE enables a function of layer-2 remote UE; a source L2-ID of the UE is changed; the UE initiates a measurement report procedure, and if at least one applicable candidate relay UE needs to be reported, and a report type is set to event-triggered or periodically-triggered; and an RRC reconfiguration message transmitted by the network is received, and the message includes an sl-PathSwitchConfig field.

### BACKGROUND

At the RAN #86 plenary meeting in December 2019, a study item on NR sidelink relaying of Release 17 was proposed (see Non-Patent Document: RP-193253, New Study Item on NR Sidelink Relaying), and was approved. Regarding the latest release of the study item, see Non-Patent Document: RP-201474, Revised SID: NR Sidelink Relay. The study item mainly studies the solution to user equipment (UE)-to-network and UE-to-UE relaying, so as to extend sidelink-based coverage. The goals of the study item include supporting a control plane procedure and service continuity.

At the RAN #91 plenary meeting in March 2021, a work item on NR sidelink relaying of Release 17 was proposed (see Non-Patent Document: RP-210904, New WID on NR Sidelink Relaying), and was approved. Regarding the latest release of the work item, see Non-Patent Document: RP-212601, Revised WID: NR Sidelink Relay. One of the goals of the work item is to standardize a sidelink control plane procedure, such as management of an RRC connection, reception of a system message, and reception of paging. The goals of the work item further include standardizing service continuity within the same base station, i.e., a switch from a direct connection between UE and a network to an indirect connection between the UE and the network through relay UE, and a switch from a connection between the UE and the network through the relay UE to a direct connection between the UE and the network.

At the RAN #94 plenary meeting in December 2021, a work item on NR sidelink relay enhancements of Release 18 was proposed (see Non-Patent Document: RP-213585, New WID on NR sidelink relay enhancements), and was approved. The goals of the work item include enhancing service continuity of sidelink relay, including: a switch from an indirect connection to an indirect connection within the same base station, and a switch from a direct connection to an indirect connection, a switch from an indirect connection to a direct connection, and a switch from an indirect connection to an indirect connection between base stations.

The present invention discusses processing performed by remote UE and relay UE for a UE identity and an RRC state of a Uu interface during a switch from a direct connection to an indirect connection and a switch from an indirect connection to an indirect connection, and processing performed by the remote UE and the relay UE when the UE identity changes.

### SUMMARY

A method performed by user equipment (UE) according to a first aspect of the present invention comprises: in the case that UE in an RRC connected state satisfies at least one of the following conditions, transmitting, by the UE, an L2-ID to a network, wherein the conditions comprise: a UE capability enquiry message transmitted by the network is received; an RRC reconfiguration message transmitted by the network is received, and the message comprises a measurement configuration of relay UE; the UE enables a function of layer-2 remote UE; a source L2-ID of the UE is changed; a source L2-ID of remote UE connected to the UE is changed; the UE initiates a measurement report procedure, and if at least one applicable candidate relay UE needs to be reported, and a report type is set to event-triggered or periodically-triggered; and an RRC reconfiguration message transmitted by the network is received, and the message comprises an sl-PathSwitchConfig field.

A method performed by user equipment (UE) according to a second aspect of the present invention comprises: transmitting, by remote UE, an RRC reconfiguration complete message to a network, the RRC reconfiguration complete message comprising a local ID of the remote UE.

A method performed by user equipment (UE) according to a third aspect of the present invention comprises: initiating, by UE, a measurement report procedure, and comprising, in a measurement result of each candidate relay UE, RRC state information of the candidate relay UE.

A method performed by user equipment (UE) according to a fourth aspect of the present invention comprises: when a source base station determines to switch remote UE from a direct connection to the base station to a connection to the base station via target relay UE, or when the source base station determines to hand over the remote UE from currently connected relay UE to another target relay UE, and if the target relay UE belongs to a target base station, transmitting, by the source base station, a handover preparation message to the target base station, the message comprising an L2-ID of the remote UE; upon receiving the handover preparation message comprising the L2-ID of the remote UE, transmitting, by the target base station, an RRC reconfiguration message comprising the L2-ID of the remote UE to the relay UE; and receiving, by the relay UE, the RRC reconfiguration message transmitted by the target base station and comprising the L2-ID of the remote UE, and performing a corresponding operation.

### Beneficial Effects of Present Invention

Reporting performed by remote UE or relay UE enables a base station to acquire a correct L2-ID of the remote UE and a correct L2-ID of the relay UE in a timely manner, thereby avoiding that a subsequent handover procedure cannot be completely performed due to absence of the L2-ID, or avoiding that use of an erroneous or non-updated L2-ID results in an exception. Reporting an RRC state of relay UE enables the base station to preferentially select relay UE in a connected state. According to the present invention, for a procedure wherein remote UE is switched from a direct connection to a network to an indirect connection to the network via relay UE, and for a procedure wherein remote UE is switched from an indirect connection to a network via relay UE to an indirect connection to the network via another relay UE, signalling exchange in a path switch procedure can be reduced, thereby shortening a delay, and ensuring quality of service.

### BRIEF DESCRIPTION OF THE DRAWINGS

FIG. 1 is a schematic diagram showing UE-to-UE relay.

FIG. 2(a), FIG. 2(b), and FIG. 2(c) are schematic diagrams respectively showing scenarios 1, 2, and 3 of UE-to-network relay.

FIG. 3 is a schematic diagram showing a procedure of a path switch from an L2 UE-to-network direct path to an indirect path.

FIG. 4 is a schematic diagram showing a basic procedure of a method performed by user equipment according to Embodiment 1 of the invention.

FIG. 5 is a schematic diagram showing a basic procedure of a method performed by user equipment according to Embodiment 2 of the invention.

FIG. 6 is a schematic diagram showing a basic procedure of a method performed by user equipment according to Embodiment 3 of the invention.

FIG. 7 is a schematic diagram showing a basic procedure of a method performed by user equipment according to Embodiment 4 of the invention.

FIG. 8 is a schematic diagram showing a basic procedure of a method performed by user equipment according to Embodiment 6 of the invention.

FIG. 9 is a block diagram showing user equipment according to an embodiment of the present invention.

### DETAILED DESCRIPTION

The following describes the present invention in detail with reference to the accompanying drawings and specific embodiments. It should be noted that the present invention should not be limited to the specific embodiments described below. In addition, detailed descriptions of well-known technologies not directly related to the present invention are omitted for the sake of brevity, in order to avoid obscuring the understanding of the present invention.

The following describes some terms involved in the present invention. For the specific meanings of the terms, please see the latest 3GPP standards and specifications.
UE: User Equipment
NR: New Radio
MAC: Medium Access Control
MAC CE: MAC control element
RLC: Radio Link Control
SDAP: Service Data Adaptation Protocol
PDCP: Packet Data Convergence Protocol
RRC: Radio Resource Control
RRC_CONNECTED: RRC connected state
RRC_INACTIVE: RRC inactive state
RRC_IDLE: RRC idle state
RAN: Radio Access Network
Sidelink: sidelink
SCI: Sidelink Control Information
AS: Access Stratum
IE: Information Element
CE: Control Element
MIB: Master Information Block
NR: New Radio
SIB: System Information Block
NG-RAN: NG Radio Access Network
DCI: Downlink Control Information
ADAPT: adaptation layer
PHY: physical layer
RB: Radio Bearer
DRB: Data Radio Bearer
SRB: Signalling Radio Bearer
eDRX: Extended DRX
Uu: Uu
ProSe: Proximity based Services
V2X: Vehicle-to-Everything
NAS: Non-Access Stratum
PC5-S: PC5 signalling
SRAP: Sidelink Relay Adaptation Protocol
U2N: UE-to-Network
U2U: UE-to-UE
L2: Layer 2
RSRP: Reference Signal Received Power
SL-RSRP: sidelink RSRP, sidelink Reference Signal Received Power
SD-RSRP: sidelink discovery RSRP, sidelink discovery message Reference Signal Received Power
RLF: radio link failure
L2-ID: Layer-2 identity (ID)

In the present invention, a network, a base station, and a RAN may be used interchangeably. The network may be a Long Term Evolution (LTE) network, a new RAT (NR) network, an enhanced Long Term Evolution (eLTE) network, or another network defined in a subsequent evolved version of the 3GPP.

In the present invention, user equipment (UE) may refer to an NR device that supports an NR sidelink relay function as described in the background, may also refer to an NR device that supports an NR sidelink relay architecture, and may also refer to an NR device or an LTE device of another type. Remote UE may refer to UE connected to the network via U2N relay UE, or may refer to UE having execution capabilities of NR sidelink U2N remote UE. The relay UE may refer to UE that supports providing a connection to the network for remote UE, or UE having the foregoing capability. Source UE and target UE may refer to two UEs connected to each other via relay UE in a UE-to-UE relay architecture.

For a U2N scenario, “relay UE”, “U2N relay UE”, and “L2 U2N relay UE” are interchangeable. “Remote UE”, “U2N remote UE”, and “L2 U2N remote UE” are interchangeable.

For a U2U scenario, “relay UE”, “U2U relay UE”, and “L2 U2U relay UE” are interchangeable. “Remote UE”, “U2U remote UE”, and “L2 U2U remote UE” are interchangeable. “Source UE”, “source remote UE”, “U2U source UE”, “U2U source remote UE”, “L2 U2U source UE”, and “L2 U2U source remote UE” are interchangeable. “Target UE”, “target remote UE”, “U2U target UE”, “U2U target remote UE”, “L2 U2U target UE”, and “L2 U2U target remote UE” are interchangeable.

In the present invention, sidelink and PC5 are interchangeable. “Feedback”, “report”, “reporting”, “transmission”, and “notification” are interchangeable. “Activation”, “employing”, “application”, “enabling”, “activating”, “implementation”, etc., are interchangeable.

In the present invention, an upper layer may refer to a ProSe layer, or a V2X layer, or a NAS layer, or a PC5-S protocol layer.

In the present invention, a ProSe layer, a V2X layer, a NAS layer, and a PC5-S protocol layer are interchangeable.

In the present invention, “switch”, “path switch”, and “handover” are interchangeable. “Change” and “update” are interchangeable.

In the present invention, “path”, “data path”, and “connection” are interchangeable. In the present invention, “L2-ID” refers to a source L2-ID unless otherwise specified. It should be noted that in the present specification, two items that are connected by “and”, “or”, or “and/or” may indicate different expression methods for the same intent in different application scenarios. It is possible that a relationship of including or being included in is present between the two items, but it is not necessary that the two items refer to completely different content.

Hereinafter, a description will be given of related art of the present invention.

A PC5 interface is an interface for performing control plane and user plane sidelink communication between UE and UE. For sidelink unicast, a PC5-RRC connection is an AS layer logical connection between a pair of a source L2-ID and a destination L2-ID. Establishment of one PC5 unicast link corresponds to establishment of one PC5-RRC connection. For the PC5 connection between the remote UE and the relay UE, the destination L2-ID of data transmitted by the remote UE is the source L2-ID of the relay UE, and the destination L2-ID of data transmitted by the relay UE is the source L2-ID of the remote UE.

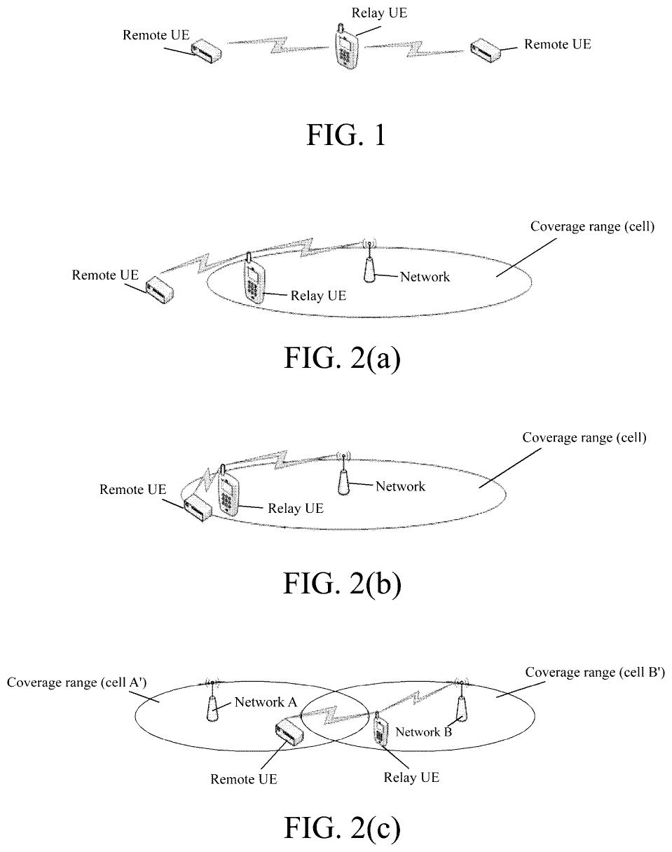

UE-to-UE relaying is as shown in FIG. 1. The left and the right are remote UEs, and the middle is relay UE. The remote UEs are respectively connected to the relay UE by means of PC5 interfaces. Because the two remote UEs are far from each other or because a communication environment is poor, the relay UE is needed to relay and forward signalling and data therebetween.

UE-to-UE relay scenarios include:
1) in coverage: the two remote UEs (i.e., the source UE and the target UE) and the relay UE are all in coverage;
2) out of coverage: the two remote UEs (i.e., the source UE and the target UE) and the relay UE are all out of coverage; and
3) partial coverage: among the two remote UEs and the relay UE, at least one UE is in coverage, and at least one UE is out of coverage.

For the NR sidelink L2 U2U relay architecture, two remote UEs (i.e., a source UE and a target UE) each set up a PC5-RRC connection to the relay UE, and the two remote UEs (i.e., the source UE and the target UE) also set up a PC5-RRC connection therebetween. The two remote UEs (i.e., the source UE and the target UE) communicate with each other via the relay UE.

UE-to-network relaying is as shown in FIGS. 2(a), (b), and (c). In scenario 1 and scenario 2 in FIGS. 2(a) and 2(b), the left side is remote UE, the middle is relay UE, and the right side is a network. In scenario 3 in FIG. 2(c), both sides are networks (e.g., networks A and B), and the middle, from left to right, is remote UE and relay UE, respectively. The remote UE and the relay UE are connected to each other by means of a PC5 interface, and the relay UE is connected to the network by means of a Uu interface. Because the remote UE is far from the network or because the communication environment is poor, the relay UE is needed to relay and forward signalling and data between the remote UE and the network.

UE-to-network relay scenarios include:
1) the remote UE is out of coverage, and the relay UE is in coverage;
2) the remote UE and the relay UE are both in coverage, and are in the same cell; and
3) the remote UE and the relay UE are both in coverage, but are in different cells (e.g., cells A′ and B′).

### Uu RRC Connection and State

A reference point between UE and a radio access network is referred to as Uu, so that a connection between the UE and the radio access network is referred to as a Uu connection. In a Uu connection, depending on the state of a Uu RRC connection, the state of UE can be an idle state (RRC_IDLE state), an inactive state (RRC_INACTIVE state), or a connected state (RRC_CONNECTED state). After an RRC connection is established, the UE may be in the RRC_INACTIVE or RRC_CONNECTED state. If no RRC connection is established, the UE is in the RRC_IDLE state.

After an RRC connection is established between the remote UE and a radio access network, the remote UE may be in the RRC_INACTIVE or RRC_CONNECTED state. If no RRC connection is established, the UE is in the RRC_IDLE state. Similarly, the relay UE may also be in one of these three states.

It should be noted that when the remote UE is in RRC_CONNECTED, the relay UE is necessarily in RRC_CONNECTED. When the remote UE is in RRC_INACTIVE/IDLE, the relay UE may be in any one of the three states, i.e., RRC_CONNECTED/INACTIVE/IDLE.

After the remote UE selects relay UE to provide a relay service for the remote UE, since there is data in an application layer that needs to be transmitted, the application layer triggers a procedure of setting up a PC5 unicast link between the ProSe layer and the relay UE. After the PC5 unicast link is set up, the ProSe layer instructs an AS layer, and the AS layer sets up a PC5-RRC connection as required by the ProSe. The remote UE can establish a Uu RRC connection to the network via the relay UE for data transmission between the remote UE and the network. The remote UE encapsulates messages of performing RRC connection setup, re-establishment, resumption, etc., to the network in PC5 signalling or data, and transmits the PC5 signalling or data to the relay UE, and the relay UE forwards the PC5 signalling or data to the network upon receiving the PC5 signalling or data. Conversely, an RRC message returned by the network is encapsulated in PC5 signalling or data by the relay UE and forwarded to the remote UE. The remote UE can acquire a system message of a cell via the relay UE. The remote UE can also receive a paging message of the network via the relay UE.

### Path Switch

A connection set up for data transmission between UE and a network may be considered as a data path or a data connection. A connection of the UE to the network via a Uu interface may be considered as a direct connection or a direct path. A connection of the UE to the network via relay UE may be considered as an indirect connection or an indirect path. Connections of the UE to the network via different relay UEs may be considered as different data paths. A data path change may be referred to as a path switch. The UE in the RRC_CONNECTED state may perform a path switch, and the path switch is initiated by the network. There are two types of path switches, i.e., intra-base station switches and inter-base station switches. Each type may be further divided into: a direct-to-indirect path switch, an indirect-to-direct path switch, and an indirect-to-indirect path switch.

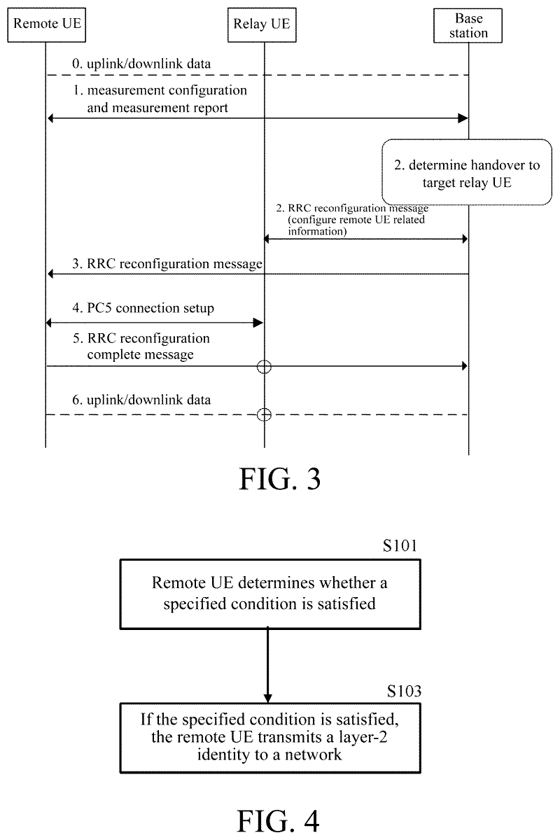

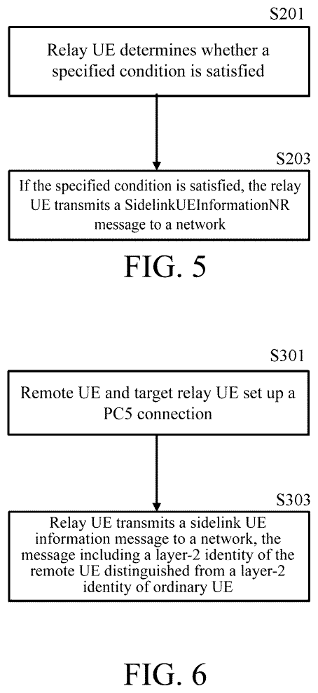

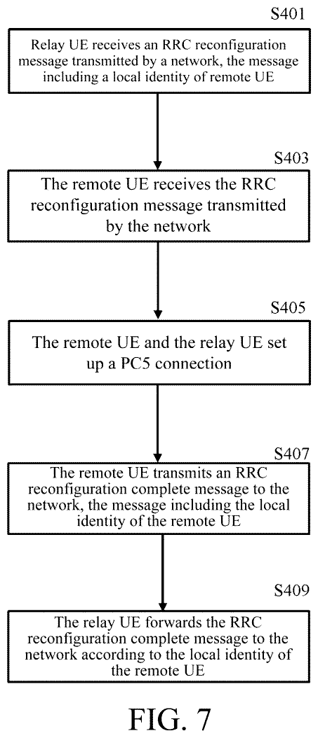

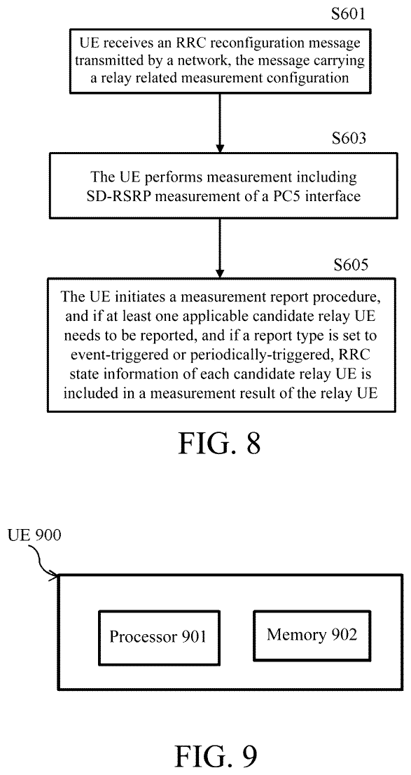

A possible implementation procedure of the direct-to-indirect path switch is shown in FIG. 3. A network configures a measurement parameter for remote UE in the RRC_CONNECTED state directly connected thereto, and a relay related measurement object may be configured. The remote UE submits a measurement report to the network. The network refers to the measurement report to determine whether to switch the remote UE so that the remote UE is connected to the network via relay UE. After the network determines target relay UE, the network prepares to initiate a path switch. The network configures, for the target relay UE via an RRCReconfiguration message, parameters related to the remote UE, which include an L2-ID of the remote UE and a local ID (allocated by the network) of the remote UE. The information may be used so that after the remote UE and the target relay UE set up a PC5 connection, the relay UE forwards an RRCReconfigurationComplete (reconfiguration is complete) message to a base station. The network transmits an RRCReconfiguration message to the remote UE to initiate a path switch, and the RRCReconfiguration message includes an L2-ID of the target relay UE. The remote UE initiates PC5 connection setup to the target relay UE. After the PC5 connection is set up, the remote UE transmits the RRCReconfigurationComplete message to the network. The message is forwarded to the network via the relay UE, and a path switch procedure is completed.

A typical scenario discussed in the present invention is as follows: in an L2 U2N architecture, how remote UE and/or relay UE reports L2-ID information to a network in a timely manner, thereby avoiding that a subsequent path switch procedure cannot be performed due to absence of the L2-ID, or avoiding that use of an erroneous or non-updated L2-ID results in an exception. In a direct-to-indirect or indirect-to-indirect path switch procedure, the present invention can reduce signalling exchange in the path switch procedure, thereby shortening a delay, and ensuring quality of service.

Hereinafter, several embodiments of the present invention for addressing the above problems are described in detail.

### Embodiment 1

The present embodiment is related to L2 U2N remote UE, and includes steps S101 and S103.

Optionally, in step S101, determining, by UE in RRC_CONNECTED, whether a specified condition is satisfied, where the specified condition is at least one of the following:
a UECapabilityEnquiry (UE capability enquiry) message transmitted by a network is received;
after the UE capability is reported to the network;
an RRCReconfiguration (RRC reconfiguration) message transmitted by the network is received, and carries a measurement configuration;
an RRCReconfiguration message transmitted by the network is received, and carries a relay related measurement configuration, e.g., a relay measurement object information element (measObjectRelay IE);
a function of remote UE is capable or enabled;
an L2 relay related function (i.e., a function of remote UE) is capable or enabled;
a source L2-ID of the UE is changed;
when the UE initiates a measurement report procedure, and if at least one applicable candidate L2 U2N relay UE needs to be reported, and if a report type (reportType) is set to event-triggered (eventTriggered) or periodically-triggered (periodical); and
an RRCReconfiguration message transmitted by the network is received, and the message includes sl-PathSwitchConfig (a sidelink-path switch configuration).

Optionally, an L2-ID transmitted by the UE is a source L2-ID (notified or provided by an upper layer to an AS layer) allocated by the UE.

Optionally, in step S103, if the UE satisfies at least one of the above specified conditions, transmitting, by the UE, an L2-ID to a network in one of the following manners:
transmitting a UECapabilityInformation (UE capability information) message to the network, the message including the source L2-ID of the UE, or a field included in the message and used to identify the UE L2-ID being set to the source L2-ID of the UE;
transmitting a SidelinkUEInformationNR (NR sidelink UE information) message to the network, the message including the source L2-ID of the UE, and a field included in the message and used to identify the UE L2-ID being set to the source L2-ID of the UE;
transmitting a measurement report (MeasurementReport) message to the network, a measurement result of the (each) candidate relay UE in the message including the source L2-ID of the UE (i.e., the remote UE), or a field included in the (each) measurement result and used to identify the L2-ID of the UE (i.e., the remote UE) being set to the source L2-ID of the UE;
transmitting a ULInformationTransfer (uplink information transfer) message to the network, the message including the source L2-ID of the UE, or a field included in the message and used to identify the UE L2-ID being set to the source L2-ID of the UE; and
newly defining a Uu RRC message (for example but not limited to: UE L2-ID information UEL2IDInformation message) used to transmit the source L2-ID of the UE to the network.

Optionally, when the L2-ID is transmitted to the network in the above manner, if the UE L2-ID is changed, the original UE L2-ID and the changed UE L2-ID may be both included or set, or a local ID of the UE and the UE L2-ID may be both included or set. Specifically, transmission of a SidelinkUEInformationNR message to the network is used as an example. Upon reception of an indication from the upper layer indicating that the source L2-ID is changed, a SidelinkUEInformationNR message is transmitted, and the message includes the original UE L2-ID and the changed UE L2-ID (the changed UE L2-ID may be provided by the upper layer to the AS layer), or the message includes the local ID of the UE and the changed UE L2-ID.

Optionally, for transmitting the UE L2-ID to the network via a measurement report, the measurement report may carry one L2-ID of the UE. That is, for different relay UEs, the UE uses the same UE L2-ID. Alternatively, for each candidate relay UE, a different UE L2-ID is carried. In this case, the AS layer may need to notify the upper layer of measured relay UE information (e.g., an L2-ID of the relay UE). The upper layer may provide, to the AS layer, different UE source L2-ID information for different relay UEs.

Optionally, the UE transmits a UECapabilityInformation message, or a MeasurementReport message, or a ULInformationTransfer message, or UECapabilityInformation, or a newly defined Uu RRC message by submitting an RRC message to a lower layer to transmit the same.

The UE supports an L2 U2N path switch.

### Embodiment 2

The present embodiment is related to L2 U2N relay UE, and includes steps S201 and S203.

Optionally, in step S201, determining, by UE in RRC_CONNECTED, whether a specified condition is satisfied, where the specified condition is at least one of the following:
a UECapabilityEnquiry (UE capability enquiry) message transmitted by a network is received;
after the UE capability is reported to the network;
an RRCReconfiguration message transmitted by the network is received, and carries a measurement configuration;
a source L2-ID of the UE is changed;
a source L2-ID of remote UE connected to the UE is changed;
an RRCReconfiguration message transmitted by the network is received, and the message includes sl-PathSwitchConfig (a sidelink-path switch configuration); and
a PC5 connection between the UE and remote UE is set up.

Optionally, an L2-ID transmitted by the UE is a source L2-ID (notified or provided by an upper layer to an AS layer) allocated by the UE, or a source L2-ID of the remote UE connected to the UE.

Optionally, in step 203, if the UE satisfies at least one of the above specified conditions, transmitting, by the UE, a SidelinkUEInformationNR message to the network, the message including at least one of the following information:
a source L2-ID of the UE;
a source L2-ID of the remote UE connected to the UE (i.e., a DestinationIdentity field is set to the source L2-ID of the remote UE);
an original source L2-ID and a changed source L2-ID of the UE;
a local ID of the remote UE connected to the UE; and
an original source L2-ID of the remote UE connected to the UE and a changed source L2-ID of the remote UE.

The original source L2-ID may be locally stored by the AS layer or indicated by the upper layer, and the changed source L2-ID is indicated by the upper layer. If the original source L2-ID of the remote UE connected to the UE and the changed source L2-ID of the remote UE need to be included, in a possible implementation manner, the changed source L2-ID of the remote UE may be indicated by newly adding, e.g., a NewDestinationIdentity field, and the original source L2-ID is indicated by the DestinationIdentity field.

### Embodiment 3

The present embodiment is related to L2 U2N, and includes steps S301 and S303. Optionally, in step S301, for a direct-to-indirect path switch or an indirect-to-indirect path switch procedure, after remote UE receives an RRCReconfiguration message transmitted by a network and carrying sl-PathSwitchConfig, or after the remote UE selects or reselects relay UE, setting up, by the remote UE and target relay UE, a PC5 connection.

Optionally, in step S303, transmitting, by the relay UE, a SidelinkUEInformationNR message to the network, the message including an L2-ID of the remote UE distinguished from an L2-ID of ordinary UE. In addition to that the relay UE and the remote UE have a PC5 connection therebetween, the relay UE and an ordinary UE may also have a PC5 connection therebetween simultaneously, and the network needs to be capable of distinguishing between the two types of UEs, so as to perform relay-related configuration on the remote UE and the relay UE. In order to distinguish between the ordinary UE and the remote UE, the SidelinkUEInformationNR message needs to distinguish between destination L2-IDs belonging to the remote UE and destination L2-IDs belonging to the ordinary UE.

A possible implementation manner may be as follows: A DestinationIdentity (destination identity) field is used to identify the L2-ID of the ordinary UE, and another new field (e.g., RemoteDestinationIdentity or any field capable of indicating that the L2-ID is the L2-ID of the remote UE rather than the L2-ID of the ordinary UE) different from the field is used to identify the L2-ID of the remote UE. Another possible implementation manner may be as follows: when the SidelinkUEInformationNR message is transmitted, a piece of indication information (e.g., a one-bit indication bit: isRemoteUE) in TxResourceReq (a transmission resource request) is set, and the indication information indicates whether peer UE is remote UE. If the peer UE is remote UE, the indication bit is set to TRUE (true). Optionally, the relay UE may transmit the SidelinkUEInformationNR message to the network when an upper layer requests to set up a PC5-RRC connection or when the upper layer indicates that a PC5 connection has been set up.

Optionally, step S301 may also be any procedure that triggers the relay UE to transmit SidelinkUEInformationNR, e.g., a scenario such as a radio link failure. Optionally, if a radio link failure triggers transmission of SidelinkUEInformationNR, when the SidelinkUEInformationNR message is transmitted, a piece of indication information (e.g., a one-bit indication bit: isRemoteUE) in SL-Failure (a sidelink failure) is set, and the indication information indicates whether peer UE is remote UE. If the peer UE is remote UE, the indication bit is set to TRUE (true).

### Embodiment 4

The present embodiment is related to L2 U2N, and includes steps S401 to S409.

Optionally, in step S401, receiving, by relay UE, an RRCReconfiguration message transmitted by a network, the message including a local ID of remote UE.

If the message includes a remote UE add modify (sl-RemoteUE-ToAddModList) information element, and if the information element includes a remote UE L2 identity (sl-L2Identity-Remote) field, for each sl-L2Identity-Remote value, if the sl-L2Identity-Remote value is not part of current UE configurations, the following operation is performed: if an associated local identity (sl-LocalIdentity) is not part of the current UE configurations, the L2-ID and the local ID of the remote UE are stored, and/or an SRAP entity is configured; or otherwise, for each remote UE local ID that is part of the current UE configurations, the L2-ID of the remote UE is stored and/or an SRAP configuration is modified.

If the message includes a remote UE add modify (sl-RemoteUE-ToAddModList) information element, and if the information element does not include a remote UE L2 identity (sl-L2Identity-Remote) field, the following operation is performed: if a local identity (sl-LocalIdentity) is not part of the current UE configurations, the local ID of the remote UE is configured or stored, and/or an SRAP entity is configured; or otherwise, for each remote UE local ID that is part of the current UE configurations, an SRAP configuration is modified.

Optionally, in step S403, receiving, by the remote UE, an RRCReconfiguration message transmitted by the network, the message including sl-PathSwitchConfig, the local ID of the remote UE, and an L2-ID of target relay UE.

Optionally, in step S405, setting up, by the remote UE and the relay UE, a PC5 connection.

Optionally, in step S407, transmitting, by the remote UE, an RRCReconfigurationComplete message to the network, the message including the local ID of the remote UE, and the message being required to be forwarded via the relay UE. Optionally, the local ID of the remote UE may also be included in a header of an SRAP layer.

Optionally, in step S409, forwarding, by the relay UE, the RRCReconfigurationComplete message to the network according to information such as the local ID of the remote UE. Optionally, the relay UE transmits SidelinkUEInformationNR to the network, and the message includes the L2-ID and the local ID of the remote UE.

### Embodiment 5

The present embodiment is related to a path switch between L2 U2N base stations. When a source base station determines to switch remote UE from a direct connection to the base station to a connection to the base station via target relay UE, or determines to hand over remote UE from currently connected relay UE to another target Relay UE, i.e., determining a direct-to-indirect path switch or an indirect-to-indirect path switch, and if the target relay UE belongs to a target base station, the source base station transmits a handover preparation (HandoverPreparationInformation) message to the target base station. The message includes an L2-ID of the remote UE that needs to perform the path switch.

Upon receiving the HandoverPreparationInformation message including the L2-ID of the remote UE, the target base station transmits, to relay UE, an RRCReconfiguration message including the L2-ID of the remote UE.

The relay UE receives the RRCReconfiguration message transmitted by the target base station and including the L2-ID of the remote UE, and configures adaptation layer information. After an RRCReconfigurationComplete message transmitted after the switch of the remote UE is received, the message is forwarded to a network.

### Embodiment 6

The present embodiment is related to L2 U2N, and includes steps S601, S603, and S605.

Optionally, in step S601, receiving, by UE, an RRCReconfiguration message transmitted by a network, the message carrying a relay related measurement configuration, e.g., a relay measurement object information element (measObjectRelay IE).

Optionally, in step S603, performing, by the UE, measurement including SD-RSRP measurement of a PC5 interface.

Optionally, in step S605, initiating, by the UE, a measurement report procedure, and if at least one applicable candidate L2 U2N relay UE needs to be reported, and if a report type (reportType) is set to event-triggered (eventTriggered) or periodically-triggered (periodical), including, in a measurement result of each candidate relay UE, RRC state information of the relay UE. The RRC state information of the relay UE may be included in a discovery message or a PC5 broadcast message, so as to be acquired by remote UE.

### Embodiment 7

The present embodiment is related to L2 U2U, a scenario wherein source UE is connected to target UE via relay UE.

For source UE, optionally, when an L2-ID of the source UE associated with relay UE is changed and updated, the source UE transmits a PC5-RRC message or a PC5-S message to target UE, and the message includes the original L2-ID and the updated L2-ID. Optionally, when an L2-ID of the source UE associated with the target UE is updated, the source UE transmits a PC5-RRC message or a PC5-S message to the relay UE, and the message includes the original L2-ID and the updated L2-ID.

For target UE, optionally, when an L2-ID of the target UE associated with relay UE is updated, the target UE transmits a PC5-RRC message or a PC5-S message to source UE, and the message includes the original L2-ID and the updated L2-ID. Optionally, when an L2-ID of the target UE associated with the source UE is updated, the target UE transmits a PC5-RRC message or a PC5-S message to relay UE, and the message includes the original L2-ID and the updated L2-ID.

For relay UE, optionally, when an L2-ID of the relay UE associated with source UE is updated, the relay UE transmits a PC5-RRC message or a PC5-S message to target UE, and the message includes the original L2-ID and the updated L2-ID. Optionally, when an L2-ID of the relay UE associated with the target UE is updated, the relay UE transmits a PC5-RRC message or a PC5-S message to the source UE, and the message includes the original L2-ID and the updated L2-ID.

The PC5-RRC message may be a RemoteUEInformationSidelink (remote UE sidelink information) message, or a newly added PC5-RRC message, or any PC5-RRC message capable of including L2-ID information. The PC5-S message may be a link identifier update request message, or a newly added PC5-S message, or any PC5-S message capable of including L2-ID information.

FIG. 9 is a simplified structural block diagram of user equipment (UE) according to the present invention. As shown in FIG. 9, user equipment (UE) 700 includes a processor 701 and a memory 702. The processor 701 may include, for example, a microprocessor, a microcontroller, an embedded processor, and the like. The memory 702 may include, for example, a volatile memory (such as a random access memory (RAM)), a hard disk drive (HDD), a non-volatile memory (such as a flash memory), or other memories, etc. The memory 702 has program instructions stored thereon. The instructions, when run by the processor 701, can implement the above method performed by user equipment as described in detail in the present invention.

The program running on the device according to the present invention may be a program that enables a computer to implement the functions of the embodiments of the present invention by controlling a central processing unit (CPU). The program or information processed by the program may be temporarily stored in a volatile memory (for example, a random access memory (RAM)), a hard disk drive (HDD), a non-volatile memory (for example, a flash memory), or other memory systems.

The program for implementing the functions of the embodiments of the present invention may be recorded on a computer-readable recording medium. The corresponding functions may be achieved by reading programs recorded on the recording medium and executing the programs by a computer system. The phrase “computer system” herein may be a computer system embedded in the device, which may include operating systems or hardware (e.g., peripherals). The phrase “computer-readable recording medium” may refer to a semiconductor recording medium, an optical recording medium, a magnetic recording medium, a recording medium for programs that are dynamically stored for a short time, or any other recording medium readable by a computer.

Various features or functional modules of the device used in the above embodiments may be implemented or executed by circuits (for example, monolithic or multi-chip integrated circuits). Circuits designed to execute the functions described in this description may include general-purpose processors, digital signal processors (DSPs), application-specific integrated circuits (ASICs), field-programmable gate arrays (FPGAs) or other programmable logic devices, discrete gates or transistor logic, or discrete hardware components, or any combination of the above. The general-purpose processor may be a microprocessor, or may be any existing processor, controller, microcontroller, or state machine. The circuit may be a digital circuit or an analog circuit. When new integrated circuit technologies that replace existing integrated circuits emerge because of advances in semiconductor technology, one or a plurality of embodiments of the present invention may also be implemented using these new integrated circuit technologies.

Furthermore, the present invention is not limited to the embodiments described above. Although various examples of the embodiments have been described, the present invention is not limited thereto. Fixed or non-mobile electronic devices installed indoors or outdoors, such as AV equipment, kitchen equipment, cleaning equipment, air conditioners, office equipment, vending machines, and other household appliances, may be used as terminal devices or communications devices.

The embodiments of the present invention have been described in detail above with reference to the accompanying drawings. However, the specific structures are not limited to the above embodiments. The present invention also includes any design modifications that do not depart from the main idea of the present invention. In addition, various modifications can be made to the present invention within the scope of the claims. Embodiments resulting from appropriate combination of the technical means disclosed in the different embodiments are also included within the technical scope of the present invention. In addition, components with the same effect described in the above embodiments may be replaced with one another.

1-10. (canceled)

11. A User Equipment (UE), comprising a processor configured to:
determine whether the UE is a layer 2 (L2) UE-to-Network (U2N) remote UE or not,
determine, based on whether the UE is a layer 2 (L2) UE-to-Network (U2N) remote UE or not, to include a field indicating a source L2 ID of the UE provided by upper layer in a sidelink UE information message which is transmitted upon update of the source L2 ID.

12. A method performed by user equipment (UE), the method comprising:
determining whether the UE is a layer 2 (L2) UE-to-Network (U2N) remote UE or not,
determining, based on whether the UE is a layer 2 (L2) UE-to-Network (U2N) remote UE or not, to include a field indicating a source L2 ID of the UE provided by upper layer in a sidelink UE information message which is transmitted upon update of the source L2 ID.
